(19) United States
(12) Patent Application Publication
(10) Pub. No.: US 2004/0081284 A1
(43) Pub. Date: Apr. 29, 2004

(54) Identification system for X-ray sensitive film

(75) Inventor: Troy W. Livingston, Northbrook, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Livingston Products, Inc.

(21) Appl. No.: 10/635,965

(22) Filed: Aug. 7, 2003

Related U.S. Application Data
(60) Provisional application No. 60/402,833, filed on Aug. 12, 2002.

(51) Int. Cl. H05G 1/28

(52) U.S. Cl. 378/162

(57) ABSTRACT

A marker for use with X-ray sensitive film to provide identifying indicia on the film when exposed to X-ray energy is preferably made by forming indicia pockets in a support and then filling the pockets with a mixture containing a tungsten material which has X-ray absorbing characteristics. The preferred mixture is a screen printing ink and either tungsten or tungsten oxide to provide a flowable mixture that can be squeezed into the pockets. The preferred method is to engrave indicia in the pockets in a plastic block and to screen print the tungsten and ink mixture into the pockets. A metal layer may be added adjacent the indicia to filter out higher intensity X-ray passing about the edges of the indicia to remove ghost edges about the indicia thereby improving the clarity of the indicia on the X-ray film. The metal layer may be a thin strip of metal positioned in a groove in a face of a plastic block support. The metal layer may be adhered to the plastic block by an adhesive. The metal strip or an adhesive tape may be provided with a light color to contrast with the dark color of the tungsten containing material used for the indicia to provide a better contrast for the indicia.

This application claims the benefit of U.S. Provisional Patent Application No. 60/402,833, Filed: Aug. 12, 2002.

The present invention pertains to a marker for formation of identifying indicia on X-ray film

### BACKGROUND OF THE INVENTION

An improved X-ray marker capable of sufficient blocking of X-rays to form transparent identifying indicia on an X-ray sensitive film is disclosed in U.S. Pat. No. 5,394,456 to Troy Livingston and these markers have met with considerable success in the market place. This patent discloses in a preferred embodiment the formation of indicia comprised of overlapped layers to provide composite material indicia markers. The preferred and illustrated embodiment disclosed in the patent had overlapped layers of steel and aluminum materials have respective X-ray absorption characteristics, which when combined, absorb a substantial portion of the X-rays to form substantially transparent identifying indicia on the X-ray film which indicia are readily visible within the area of contrast. To provide the desired quality for the indicia, it was preferred to manufacture the letters by laser cutting the indicia from sheets of steel. While the resulting product works very well, the cost of laser cutting of the indicia from steel, then aligning, assembling and attaching them to the underlying strip of aluminum adds considerably to the cost of the final marker. Typically, the strip of aluminum with the steel, laser-cut letters are mounted in a plastic block or mounted in a snap holder which is part of a flip marker used in mammography machines.

Another much older practice in the prior art that is inferior to the marker disclosed in U.S. Pat. No. 5,394,456 is to provide lead indicia pieces. These lead indicia pieces are placed between the X-ray source and the X-ray sensitive film to block a selective portion of the X-rays imparted to the film and thereby prevent the X-rays from affecting the film over the portions of the film corresponding to the shape of the lead pieces. Typically, the lead pieces were taped in a stationary position at a location overlapping a corner of the film. The X-rays are substantially blocked over the portion of the film situated beneath the markers, typically producing a clear or light white image on the X-ray exposure in a pattern corresponding to the X-ray pieces, with the portion of the X-ray exposure immediately surrounding the clear indicia not being blocked and therefore being dark. In this manner, the lead markers form identifying indicia on the X-ray exposures.

For instance, to indicate on the X-ray exposure that it is a left side view in a particular shot, an L-shaped markers may be taped to the platen in which the film is disposed, at a location overlapping a corner portion of the X-ray sensitive film. This produces a clear L-shaped portion on the X-ray film when subjected to X-ray energy from the X-ray source, to readily identify that it is a left view in that particular X-ray exposure.

There are numerous shortcomings associated with employment of such lead markers in forming identifying indicia on X-ray film. Among these shortcomings is the toxicity of lead which may cause medical problems for persons frequently in contact with the lead. Hence, workers, who must mount and remove the lead markers to and from the film-receiving platen between each shot, and who store and clean the lead markers, are reluctant to handle the lead markers due to the medical risks they pose. Methods for forming thin lead indicia may require subjecting lead to high heat, such as in employment of laser processing, which produces toxic fumes, therefore making lead undesirable for production by such methods.

While it is possible to reverse the contrast on the X-ray film by having dark indicia on a clear or transparent area of the X-ray film, a large background area lets through too much light when observing the X-ray exposure with traditional back lighting. This results in a searchlight effect, with the back lighting shining virtually unimpeded through the large or wide clear portions of the film and shining into the viewer's eyes, and sometimes requiring the viewer to cover the indicia-bearing portion of the X-ray exposure when viewing the X-ray image.

The markers may be used with various X-ray machines doing various X-rays that present different problems to provide good X-ray absorption. For example, while it is possible to find X-ray absorbing materials for a small range of intensities of X-rays, it is desirable that marker material also be effective where the X-ray intensity varies considerably, e.g. from 8 milliamp-seconds to 300 milliamp-seconds at 25 KVA in mammographic X-rays of breasts for lumps. Small soft breasts may be X-rayed at the low end of this range. Breasts that have been subjected to radiation treatment have harder and more dense tissue requiring X-ray intensity in the upper end of this range. Materials and thicknesses that work well at the low end of the intensity range have not worked well at the high end of this intensity range.

Markers used for mammographic X-rays of breast are usually quite small in size relative to other markers such as those used for chest X-rays. Often the chest X-ray markers have four to five times thicker X-ray absorbing material than do the mammography markers. It is desirable that personalized markers also be used that identify the laboratory technician as by the technician's initials or identification number so that there is a record on the X-ray film of the identity of the person performing the X-ray procedure. Often such personalized markers are highly price sensitive and will not be purchased if they are expensive. There is a need for an improved marker for chest X-rays or other X-rays wherein the energy is quite high, e.g., 135 kilovolts versus 20-40 kilovolts used in mammography X-ray machines.

Some markers are taped in a desired position onto the platen in which the X-ray film is received to hold the markers in place during the X-ray exposure. Tape, which is currently employed to mount the lead markers to a platen, has been found to be a cumbersome and inaccurate mounting means. In many applications, several shots of a subject are required to be taken at different angles, and it is necessary to remove a previously-applied marker from the platen and tape a new marker to the platen between each different shot to identify each of the different angles. Considerable time is spent between each different X-ray exposure taping a plurality of different markers, suitable for properly identifying the particular X-ray exposure, to the platen. Also, it may be necessary to rotate the platen in any or each of three different planes between each of the different X-ray exposures, and the tape has been found to be an ineffective means of mounting the markers since it frequently allows the markers to shift or fall off during rotation of the platen. This difficulty may be overcome as in the aforementioned U.S. patent by using magnets to hold the markers that are easily attachable and detachable and that will not slip during shifting of the platen. Some markers are provided with Velcro fasteners while other markers may be provided with suction cuts or snap over connections with a wire to position the markers relative to film to locate the markers properly during the X-ray. A flip marker system used in mammography machines to quickly change or reposition markers is disclosed in this application hereinafter. Irrespective of how the markers are positioned in use, there is a need for inexpensive X-ray markers that are readily secured in position with respect to X-ray film.

### SUMMARY OF THE INVENTION

In accordance with the present invention, there is provided a new and improved marker and method for making the marker which is used to form identifying indicia on X-ray sensitive film. This is achieved by forming indicia receiving pockets in a support such as a block or strip and filling the pockets with a material mixture having X-ray absorbing characteristics. The preferred mixture includes tungsten or tungsten oxide to block the X-ray energy and a carrier material such as a screen printing ink or paint for the X-ray blocking material. In this preferred method, a mixture of tungsten or tungsten oxide and screen printing ink is formed and is squeezed or screen printed into the pockets and allowed to solidify or otherwise cure into a solid state in the pockets. The preferred pockets are indicia-shaped and are formed by engraving pockets into a face of the support which may be a small, inexpensive, thin block or strip of plastic such as a polycarbonate block. The preferred polycarbonate block is sufficiently thin that it is easily penetrated by the X-ray and does 5 leave a ghost or lightened area about the clear, white indicia showing on the dark X-ray film. One manner of engraving the indicia is to machine the pockets using a CNC cutting machine. The carrier material for the X-ray blocking material may be an epoxy material mixed with tungsten oxide and poured into the engraved pockets and allowed to cure, so long as the epoxy doesn't attack the plastic support blocks.

The preferred mixture having tungsten or tungsten oxide has a specific gravity of about eleven which compares favorably with lead which has a specific gravity of about thirteen. Stated differently, the mixture has a lead equivalency of about 90%. The specific gravity of the preferred tungsten granules is about 16.5. The preferred mixture is of about 40% by weight of white screen printing ink and about 60% by weight of tungsten oxide. The white ink and white tungsten oxide provide good contrast with a plastic block holder whether it is a clear transparent block of plastic or a black plastic snap marker used in a flip marker system for a mammography machine. This mixture also provides a good contrast with a black buckey plate or the like allowing easy visualization of the indicia on the marker. When using tungsten rather than tungsten oxide, the indicia mixture appears gray in color while using the tungsten oxide, the indicia appears white in color.

Also, if any of the mixture that is squeegeed or extruded into the indicia pockets gets on the face of the block adjacent the pockets, the block face may be wiped or sanded to remove the surplus mixture from the face. If sanded, this results in a textured, frosted surface on the face of the polycarbonate block.

One embodiment illustrated herein is that of a marker for use with mammography where the letters need only be about 0.030 to 0.040 inch in thickness. By way of example only and not by way of limitation, a 60% tungsten and a 40% screen printing ink may be squeegeed into pockets having a depth of about 0.032 to 0.050 inch and be filled to the top face Of the pocket. After drying or curing of this mixture in situ the thickness is reduced by about 0.005 to 0.008 inch to leave the dried letters with a thickness in the range of 0.030 to 0.042 inch in thickness. For mammography, the typical plastic block is about four inches in length, one-half inch in width and about 0.150 inch thick. This thin block of polycarbonate will not leave a ghost or white area on the film as may a substantially thicker block of polycarbonate.

For some uses, e.g., higher intensity X-ray machines, better indicia clarity can be achieved by adding a metal layer, e.g., a thin strip of metal as a backing to the tungsten containing indicia to act as a filter to filter out higher energy X-rays that go about the edges of the indicia and cause ghost appearance about the indicia edges. Herein, the illustrated metal layer is a strip of stainless steel, although other metals may be used. For mammograms, the tungsten containing indicia may be about 0.030 to 0.050 inch thick and the metal layer may be about 0.004 to 0.012 inch thick. For other general X-rays such as chest X-rays, that use high energies, e.g., about 135 kilovolts, the tungsten containing indicia may be as much as ⅛ inch thick and the metal layer may be about 0.020 inch thick.

The X-ray energy used in mammography may vary from one machine manufacturer to another machine manufacturer. The marker may be tuned to filtering out any ghosts about the indicia by adjusting the thickness of the metal layer. The higher X-ray intensity machines will need a thicker metal strip, e.g., a stainless steel strip, then will lower X-ray intensity machines.

### BRIEF DESCRIPTION OF THE DRAWINGS

FIG. 1 is an enlarged perspective view showing a marker embodying various features of the present invention;

FIG. 2 is a cross sectional view taken substantially along the Line 22 in FIG. 1 through the marker showing the pockets with the mixture therein;

FIG. 3 is a cross-sectional view of another embodiment of the marker;

FIG. 4 is a perspective view of a flip marker system useable within a tiltable buckey plate of an X-ray machine; and

FIG. 5 is a perspective view of a snap holder having a suction cup;

FIG. 6 is a plan view of a marker embodying the invention and useable with the flip marker system of FIG. 4;

FIG. 7 is an illustration of a mammography x-ray machine; and

FIG. 8 is a cross-sectional view of an embodiment having a metal layer for filtering high energy X-rays.

### DETAILED DESCRIPTION OF THE PREFERRED EMBODIMENT

As shown in the drawings for purposes of illustration, there is disclosed a marker 20 that comprises a support 24 which is preferably in the shape of a block or strip having indicia 26 such as the letters and numbers “R-ml”. The indicia are made of a material that absorbs the X-ray energy to provide transparent indicia on the X-ray sensitive film 30, while others of the X-rays pass through the block 24 providing a dark or black background about the transparent letters to provide an excellent contrast so that the indicia is readily visible.

In accordance with the present invention, the support 24 is provided with pockets 28 into which is deposited a liquid or extrudable mixture that substantially fills the pocket. Preferably, the indicia mixture comprises an X-ray absorbing material having a high specific gravity approaching that of lead, which has a specific gravity of about thirteen. Good results have been achieved using a mixture having a specific gravity of about 11. Stated differently, good results have been achieved using a mixture that has about a 90% lead equivalency. The preferred mixture is either tungsten or tungsten oxide and a screen printing ink mixed in a ratio of about a 60% by weight of the tungsten ingredient and about 40% by weight of screen printing ink ingredient. Herein, the 60/40% mixture of tungsten oxide and screen printing ink forms a paste like mixture that is too thick to be screen printed but which can be readily forced by a squeegee or the like into the pockets. Thereafter, the squeegee or a cloth or the like is preferably wiped across the face 25 of the block 24 to wipe excess mixture from the pockets and the face 25 of the block. The printing ink solidifies, in situ, and retains the mixture in the pockets. The printing may be a type that cures to solidify in situ.

In the preferred method, the indicia are formed inexpensively by machining them in the plastic block 24 as by using a CNC cutting machine. This avoids the laser cutting of the metal indicia and then the mechanical work of aligning and assembling the indicia on the aluminum strip and then mounting them on a plastic block snap holder. The cutting machine can easily be programmed to provide indicia of various kinds including logos, etc., as well as alpha/numeric indicia.

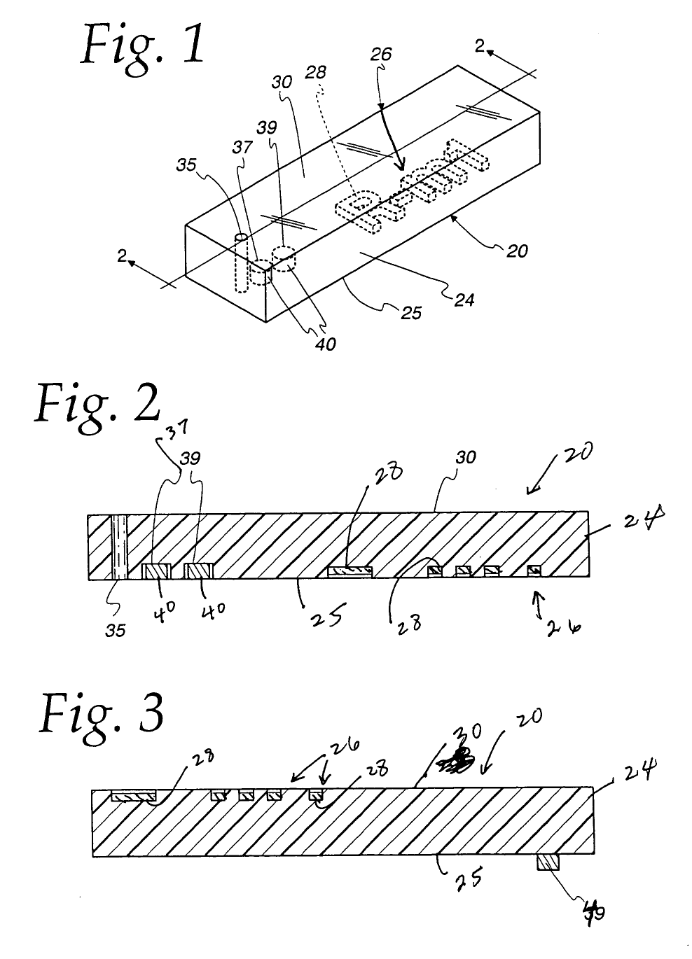

In accordance with an important aspect of the invention, the CNC machine can be readily programmed to engrave the pockets reversely so that the alpha/numeric indicia may be read correctly from left to right when reading the X-ray from the back side of the X-ray film. This is the case of the marker shown in FIG. 1, where the pockets 28 are formed in a bottom fare or side 25 of the block while the top side of the block is free and clear of any pockets 28. The block with reversely engraved indicia pockets 28 may then have them filled with the mixture and then the mixture is forced by a squeegee blade or the like to completely fill the pockets 28 with a pressure force trying to compress the mixture within the pocket. A blade or cloth may be wiped or scraped across the block face 25 to remove any excess material from this face of the block.

By way of example only and not by way of limitation, the illustrated marker for use with a mammography machine has a polycarbonate body or support 24 of rectangular shape that is about 41″ long, ½″ in depth and one-half inch in width. The pockets preferably are about 0.032 to 0.050 in depth and after solidifying the ink mixture shrinks in the pocket from about 0.005 to 0.008 inch leaving a depth of about 0.030 inch to 0.042 inch in cross-sectional thickness for the dried mixture. In order to make a darker image on the x-ray film, the depth of the pocket and the thickness of the mixture is increased from the lower end of the range, e.g., 0.035 to 0.047 thick dried mixture. It appears that the x-rays tend to scatter, experience parallax or otherwise tend to lose some of the image because the x-ray's source is at a relatively long distance from the marker and x-ray film. Manifestly, depending on the specific gravity of the absorbing material and the darkness preferred by the end user of the x-rays, the cross-sectional thickness of the material may be varied from the preferred range of 0.032 to 0.050 inch for the mixture.

Manifestly, the pockets 28 could have formed without being reversed and in upper face 30 of the block-shaped support 24 rather than on the lower face 25, as shown in FIG. 1. For many uses or applications, the indicia will not be reversely formed while for others the indicia will be reversely formed.

In the embodiment of FIG. 1, the block support 20 is formed with a hole 35 that extends completely through the support from the top face 30 to the bottom face 25 of the block. The hole 35 to receive a mounting projection. Also, there are a pair of aligned circular pockets 37 and 39 formed in the bottom face and containing magnets 40 to provide slick control positioning of the marker. As stated above, the preferred and illustrated marker is a polycarbonate block which is a clear transparent plastic that is thin enough that the x-ray energy will pass therethrough without leaving a mark or lightened area on the x-ray film such at only letters R-ml will be seen as clear indicia on the dark x-ray films.

In the embodiment of FIG. 3, the indicia pockets 28 are in the upper face 30 of the block support and contain the indicia 26 of the x-ray absorbing mixture such as a mixture of tungsten oxide and printing ink that has dried, in situ, in the pockets to form the indicia 26 such as R-ml. The block support 24 in FIG. 3 is a polycarbonate block and has a magnet 49 projecting downwardly from a lower side or face 25 of the block support.

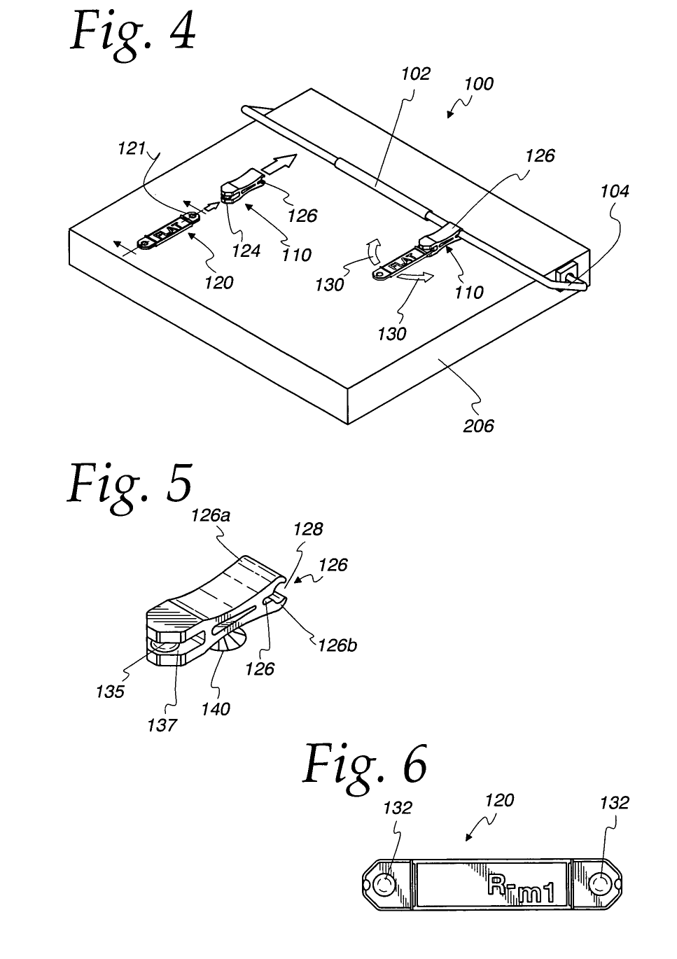

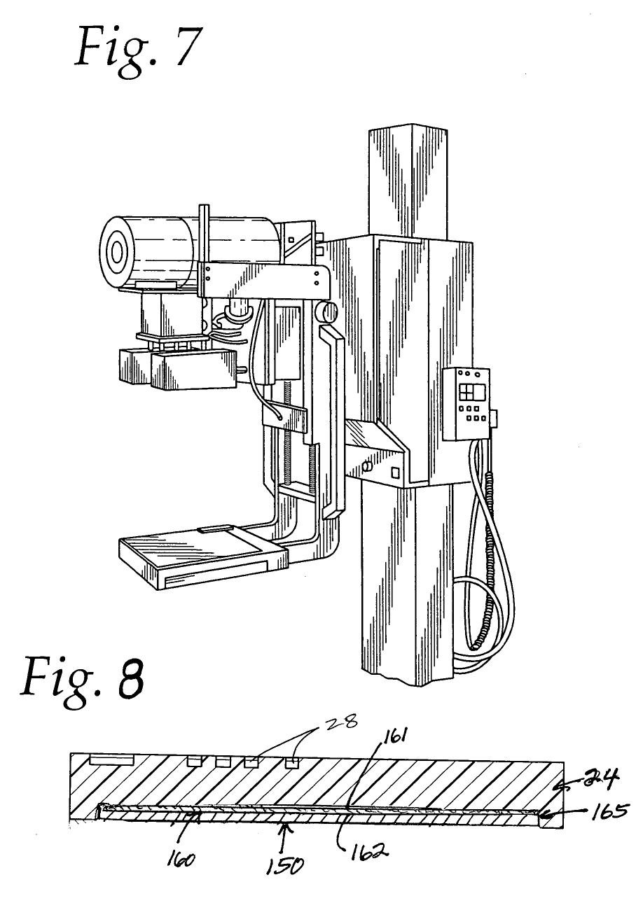

For use with x-ray films used in mammography, there may be provided a flip marker system 100 (FIG. 4) which comprises a pivoted rod 102 pivotally mounted at its opposite ends 104 to the buckeye 206 to which are releasably attached snap holders 110 for markers 120. The snap markers 120 are gripped at one end by pushing a snap filtering end 122 of the marker end into a groove or jaw 124 of a snap holder. This snap fit releasably holds the marker which can be pulled from the jaws when it is. desired to remove the marker. The opposite end of the snap holder has a rounded jaw 126 with upper and lower spaced jaw portions 126a and 126b having internal curved surfaces 126c to engage and pivot on the rod 202. The space 128 between the rounded jaws is smaller than the rod diameter so that the rod flexes the rounded jaws apart to enter into the larger rounded internal space at which time the outer flexed ends return to their unflexed positions. Thus, the snap holders may be snap fitted onto the rod.

Preferably, the markers are pivotally connected at their snap fitted ends so that they can be rotated or swung in opposite directions as shown by the arrows 130 in FIG. 4. This pivoting is achieved by having circular indentations 132 (FIG. 6) in the snap fitting ends 121 and having a matching rounded dome or projection 135 (FIG. 5) on the internal surface 137 of one of the jaws. When the marker end is snap fitted into the jaws, the indentation 132 fits into the dome-shaped projection 135 and is pivotally mounted thereby to swing in either direction. The markers have upper and lower indentations 132 in the upper and lower surfaces of the respective marker ends. This allows the markers to be flipped and reversed as needed by simply removing them from the snap holder, turning them over, and reinserting them into the holders. In the embodiment shown in FIG. 5, the snap holder is provided with a suction cup 140 to hold the snap holder against shifting when the suction cup is applied to the buckeye or the like.

In accordance with another embodiment, which is illustrated in FIG. 8, a metal layer 150 is used in the marker adjacent the indicia 26 and is made with tungsten oxide or tungsten ingredients, as described above, for absorbing higher X-ray energy that tends to pass around the sides of the indicia and provide ghosts about the indicia. This extra, unwanted high energy passing around the sides of the indicia is absorbed by the metal layer to provide improved clarity to the indicia, that is, the ghosting effects are eliminated or substantially reduced. For mammography using 20-40 kilovolts, the metal layer 150 is preferably a stainless steel strip that is about 0.004 to 0.012 inch in thickness. In a sense, the stainless steel strip layer acts as a filter to filter out the high energy X-rays that are not filtered out by the indicia 26 about the periphery of the indicia.

The stainless steel layer 150 may be placed at below or on the top of the indicia.

For chest X-ray or other general X-ray operations using high energy X-rays in the range of 135 kilovolts, the thickness of the tungsten oxide or tungsten containing indicia is preferably increased to about ⅛ inch thick and the stainless steel layer is increased to about 0.020 inch in thickness.

The thickness of the filter metal layer may be adjusted from the thicknesses, which is given only by way of illustration herein, in order to adjust the filtering capacity to absorb the higher energy X-rays, which, if not absorbed, cause ghosting or a lack of clear image indicia. Likewise, the thickness of the tungsten containing indicia letters may be varied depending on the level of the energy of the X-rays desired to be absorbed by the tungsten containing indicia letters. While it is preferred to have the indicia formed as about described, the present invention is not limited to this exact method of making the indicia for combining with the filtering layer 150 of metal because the indicia could be made in other manners and then combined with the metal layer 150 to make the marker.

The preferred metal layer 150 is a strip of stainless steel and it is adhered to the block-shaped support 24 by a white adhesive tape 160 that is double coated with an adhesive layer 161 and 162 on each side of the tape. One side of the tape is adhered to the support block and the other side is adhered to the metal strip. The white coating of the adhesive strip provides a good contrast to the generally black color of the tungsten material of the indicia to make the indicia easier to read particularly when the marker is on a black colored flip marker system 100. It is preferred to provide a groove 165 in the underside of the block-shaped support to receive the metal strip therein as shown in FIG. 8.

What is claimed is:

1. A marker for use with X-ray sensitive film for disposition between an X-ray source and the X-ray sensitive film to provide identifying indicia on the X-ray sensitive film when the film is exposed to X-ray energy from the X-ray source, the marker comprising:
a support of material that does not substantially absorb X-ray energy so that the support is not visible on the X-ray sensitive film;
indicia forming pockets in the support for forming the shapes of the identifying indicia; and
a mixture of material in the pockets forming the indicia comprising a predetermined percentage of a tungsten material to provide X-ray absorbing characteristics to absorb X-ray energy to form substantially transparent identifying indicia which are readily visible when the film has been exposed to the X-rays.

2. A marker in accordance with claim 1 wherein the support comprises:
a plastic block having the indicia forming pockets engraved on one side thereof.

3. A marker in accordance with claim 2 wherein the mixture of material forming the indicia comprises a screen printing ink mixed with the tungsten material to provide a flowable material.

4. A marker in accordance with claim 3 wherein the tungsten material is tungsten oxide.

5. A marker in accordance with claim 3 wherein the screen printing ink is a white ink to improve contrast of the indicia.

6. A marker in accordance with claim 3 comprising:
the mixture of material in the pockets extending to adjacent the side of the block.

7. A marker in accordance with claim 1 in which the pockets are reversely cut into a face of the support.

8. A marker in accordance with claim 1 in which the support comprises:
a block of transparent plastic;
a hole extending through the block from one face to the opposite face of the block; and
at lease one magnet in a recessed pocket in the face of the block having the reversely cut pockets which contain the indicia mixture.

9. A marker in accordance with claim 1 in which the pockets are cut to appear in alpha/numeric characters when viewed from the facing side of the support.

10. A marker in accordance with claim 9 in which the pockets are formed on the top side of the marker; and
at least one magnet being on the lower side of the marker.

11. A marker in accordance with claim 1 wherein the marker is for use in a flip marker system, the marker comprising:
a flip marker body having an end to snap into a holder of the flip marker system; and
the support and indicia mixture in the support being mounted in a central cavity in the flip marker body.

12. A marker in accordance with claim 4 comprising:
a textured frosty surface on the block.

13. A marker for use with X-ray sensitive film for disposition between an X-ray source and the X-ray sensitive film to provide identifying indicia on the X-ray sensitive film when the film is exposed to X-ray energy from the X-ray source, the marker comprising:
a support of material that does not absorb X-ray energy so as not to be visible on the X-ray sensitive film;
indicia forming pockets in the support reversely engraved to reversely readable identifying indicia; and
a mixture of material in the pockets comprising a predetermined percentage of a tungsten material to provide X-ray absorbing characteristics to absorb X-ray energy to form normal readable, substantially transparent identifying indicia corresponding to the material on the film which are readily visible when the film has been exposed to the X-rays with the reversely engraved letters positioned to be read from the rear side of the exposed X-ray film.

14. A marker in accordance with claim 13 wherein the mixture of material has a specific gravity of at least eleven.

15. A marker in accordance with claim 13 wherein the mixture has an absorption equivalency of at least 90% of that of lead.

16. A marker in accordance with claim 13 comprising a positioning device associated with support for positioning the support relative to the X-ray film.

17. A method of making a marker for use with X-ray sensitive film for disposition between an X-ray source and the X-ray film to provide identifying indicia on the X-ray when the film is subjected to X-ray energy from the X-ray source, the method comprising:
providing a support;
forming pockets in the support in the shape of indicia; and
filling the pockets with an indicia forming mixture of material having X-ray absorbing characteristics to absorb X-ray energy to form substantially clear identifying indicia on the X-ray film, the clear indicia being readily visible when the film has been exposed to the X-rays.

18. A method in accordance with claim 17 comprising:
providing an extrudable mixture of material for the indicia containing a tungsten ingredient and filling the pockets therewith; and
allowing the extrudable mixture to solidify in the pockets.

19. A method in accordance with claim 17 comprising:
solidifying the mixture in situ in pockets.

20. A method in accordance with claim 17 comprising:
providing an indicia mixture comprising screen printing ink and a tungsten ingredient; and
wherein the filling of the pockets comprises forcing the mixture of ink and tungsten ingredient into the pockets.

21. A method in accordance with claim 17 comprising forcing the indicia forming mixture into the pockets with a squeegee and removing any excess material from the surface of the block.

22. A method in accordance with claim 17 comprising engraving the pockets in a surface of the support.

23. A method in accordance with claim 22 comprising engraving reversely formed, alpha/numeric indicia into a surface of the support.

24. A method in accordance with claim 21 wherein the engraving of the pockets comprises:
using a CNC machine to engrave letters and numbers thereby forming the pockets in the plastic block.

25. A method in accordance with claim 21 comprising:
providing a block of plastic as the support and engraving the pockets in one face of the plastic block.

26. A method in accordance with claim 23 comprising:
after filling the pockets removing any excess mixture from the face of the block.

27. A method in accordance with claim 17 comprising:
providing a metal layer adjacent the indicia to filter high X-ray energy to provide improved clarity for the identifying indicia.

28. A marker for use with X-ray film to provide identifying indicia on the film comprising:
indicia formed of a predetermined percentage of a tungsten material to provide X-ray absorbing characteristics to absorb X-ray energy to form the identifying indicia; and
a metal layer adjacent the indicia to filter high X-ray energy about the indicia to provide improved clarity to the identifying indicia on the film.

29. A marker in accordance with claim 28 wherein the metal layer comprises:
a metal backing of stainless steel.

30. A marker in accordance with claim 28 wherein the marker for mammography has a metal layer of about 0.004 to 0.012 inch in thickness.

31. A marker in accordance with claim 28 wherein the tungsten material has a thickness of about 0.020 inch.

32. A marker in accordance with claim 28 wherein the marker is used for general X-rays and has a metal layer of about ⅛ inch in thickness.

33. A marker in accordance with claim 32 wherein the tungsten material is about 0.020 inch in thickness.

34. A marker in accordance with claim 28 comprising:
the metal layer being a metal strip;
a plastic block having pockets with the indicia in one face of the block; and
the metal strip attached to an opposite face of the plastic block.

35. A marker in accordance with claim 34 comprising:
a groove in the opposite face having the metal strip disposed therein; and
an adhesive adhering the strip to the block.

36. A marker in accordance with claim 35 wherein the adhesive comprises:
a first adhesive coating on one side of an adhesive tape and a second adhesive coating on the other side of the adhesive tape; and
the adhesive tape having a light color to contrast with dark colored indicia.
